(19) United States
(12) Patent Application Publication
(10) Pub. No.: US 2011/0080384 A1
(43) Pub. Date: Apr. 7, 2011

(54) Flat Panel Display with Circuit Protection Structure

(75) Inventors: Sheng-Chao Liu, Hsin-Chu (TW); Kuang-Hsiang Liu, Hsin-Chu (TW)

(73) Assignee: AU OPTRONICS CORPORATION, Hsin-Chu (TW)

(21) Appl. No.: 12/895,922

(22) Filed: Oct. 1, 2010

(30) Foreign Application Priority Data
Oct. 1, 2009 (TW) 098133451

(51) Int. Cl. G09G 3/34; G09G 5/00

(52) U.S. Cl. 345/204; 345/107

(57) ABSTRACT

A flat panel display with a circuit protection structure is provided. The flat panel display includes a substrate, an electrode array control circuit, a driving circuit, a display panel, and a protection unit. The substrate has a first surface. The electrode array control circuit is formed on the first surface. The driving circuit is formed on the first surface and on one side of the electrode array control circuit. The display panel including a plurality of display particles is disposed on the electrode array control circuit. The electrode array control circuit controls operations of the display particles. The protection unit is formed on one side of the display panel to cover the driving circuit.

This application claims priority based on a Taiwanese Patent Application No. 098133451, filed on Oct. 1, 2009, the disclosure of which is incorporated herein by reference in its entirety.

### BACKGROUND OF THE INVENTION

1. Field of the Invention

The present invention relates to a flat panel display with a circuit protection structure; particularly, the present invention relates to a flat panel display which includes a circuit protection structure to protect the driving circuit of thin-film transistor (TFT) array formed on a substrate.

2. Description of the Related Art

There are various kinds of flat panel displays. Besides liquid crystal display (LCD) which is frequently used nowadays, electronic paper (e-paper) is another kind of flat panel display noted for its capability to mimic the appearance of ordinary ink on paper. E-paper is produced by employing technology such as electrophoretic display (EPD) or rotating balls display. The e-paper is characterized in its capability to hold texts and images indefinitely without drawing electricity and its flexibility like ordinary paper. Furthermore, E-paper has the advantages such as high dots-per-inch (DPI) density, high contrast, low power consumption, and low cost which result in the increasing awarenes of E-papers.

Various manufacturing technologies are set forth to meet the requirements such as size minimization or cost saving of electronic devices. For instance, the gate electrode driving circuit on array (GOA) technology integrates the gate electrode driving circuit of TFT array into a glass substrate so as to substitute additional driver chip and meets the objectives of space saving and cost saving.

However, electrophoretic display panel is generally disposed to contact with a glass substrate. As a result, if GOA or other similar technologies are employed to manufacture e-paper, the GOA circuit formed on the glass substrate will generally lack coverage and result in its exposure to ambient air. FIG. 1 is a schematic view of a conventional flat panel display. As shown in FIG. 1, a substrate 1 and an electrophoretic display panel 2 are disposed in contact with each other. Since the gate electrode driving circuit 3 on the substrate 1 is disposed outside the edge of the electrophoretic display panel 2, the gate electrode driving circuit 3 therefore lacks coverage and is exposed. The gate electrode driving circuit 3 could be damaged by moisture, scratch, static electricity, etc. Besides, when GOA or other similar technologies are employed to manufacture LCD, color filter will be generally employed to cover the GOA circuit formed on the glass substrate. As a result, it is generally necessary to employ a bigger color filter to cover the GOA circuit, and the cost is increased correspondingly.

### SUMMARY OF THE INVENTION

It is an objective of the present invention to provide a flat panel display with a circuit protection structure. The circuit protection structure protects the TFT array of the driving circuit formed on the glass substrate from damage by covering the TFTs to avoid the above-mentioned prior art problems.

The flat panel display of the present invention includes a substrate, an electrode array control circuit, a driving circuit, a display panel, and a protection unit. The substrate has a first surface. The electrode array control circuit is formed on the first surface of the substrate. The driving circuit is formed on the first surface and on one side of the electrode array control circuit. The display panel including a plurality of display particles is disposed on the electrode array control circuit. The electrode array control circuit controls operations of the display particles. The protection unit is formed on one side of the display panel to cover the driving circuit.

### BRIEF DESCRIPTION OF THE DRAWINGS

FIG. 1 is a schematic view of a conventional flat panel display;

FIG. 2 is a schematic view of the first embodiment of the flat panel display of the present invention;

FIG. 3 is a schematic view of an embodiment of the flat panel display shown in FIG. 2 with an additional outer frame;

FIG. 4A is a schematic view of the second embodiment of the flat panel display of the present invention;

FIG. 4B is a schematic view of the third embodiment of the flat panel display of the present invention;

FIG. 5A is a schematic view of the fourth embodiment of the flat panel display of the present invention;

FIG. 5B is a schematic view of the fifth embodiment of the flat panel display of the present invention;

FIG. 6A is a schematic view of an embodiment of the protection unit of the flat panel display of the present invention;

FIG. 6B is a schematic view of another embodiment of the protection unit of the flat panel display of the present invention; and

FIG. 6C is a schematic view of yet another embodiment of the protection unit of the flat panel display of the present invention.

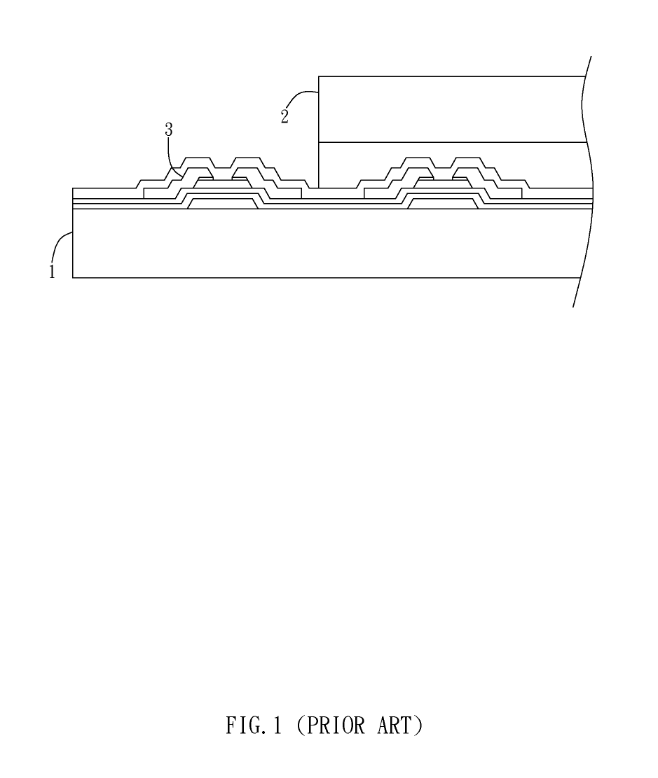

### DETAILED DESCRIPTION OF THE PREFERRED EMBODIMENT

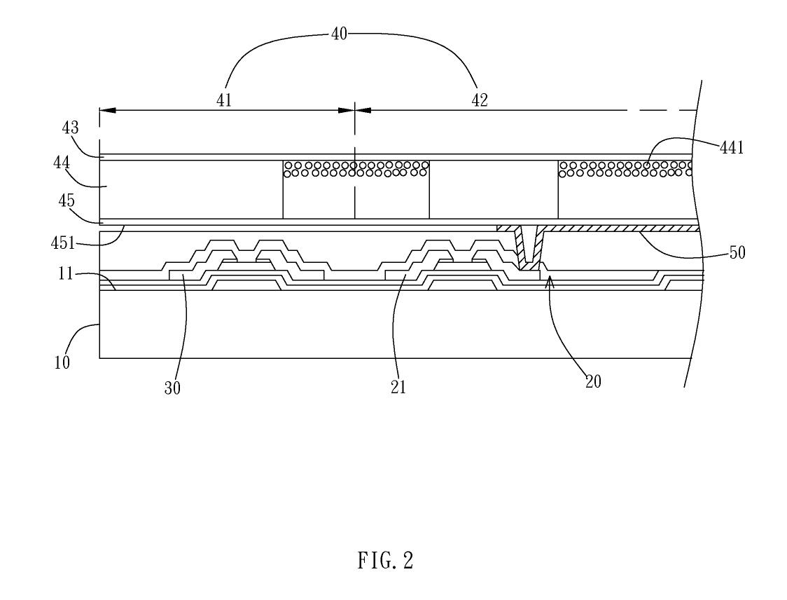

The present invention provides a flat panel display with a circuit protection structure. In the embodiment as shown in FIG. 2, the flat panel display includes a substrate 10, an electrode array control circuit 20, a driving circuit 30, an electrophoretic display panel 40, and a protection unit. The substrate 10 has a first surface 11. In a preferred embodiment, the substrate 10 can be made of glass, polymer, or other materials. The electrode array control circuit 20 is formed on the first surface 11 of the substrate 10. In a preferred embodiment, the electrode array control circuit 20 is a TFT array consisting of TFTs integrated into the substrate 10. The driving circuit 30 is formed on the first surface 11 and on one side of the electrode array control circuit 20 so that the driving circuit 30 connects and drives the electrode array control circuit 20, wherein the driving circuit 30 provides voltage to gate electrodes of TFTs. In this embodiment, the driving circuit 30 is a scanning driving unit which drives gate electrodes of TFTs of the electrode array control circuit 20.

In this embodiment, GOA technology is employed to integrate the driving circuit 30 into the substrate 10 to drive the electrode array control circuit 20 consisting of a-Si (amorphous silicon) TFTs. However, in other embodiments, the driving circuit integrated into the substrate through GOA technology can drive the electrode array control circuit consisting of p-Si (poly silicon) TFTs, wherein the p-Si TFTs can be formed through low temperature poly-silicon (LIPS) or other technologies. Furthermore, in other embodiments, other methods can be employed to integrate the driving circuit into the substrate.

As shown in FIG. 2, the electrophoretic display panel 40 disposed on the electrode array control circuit 20 is divided into a first region 41 and a second region 42. The first region 41 extending from one side of the second region 42 covers the driving circuit 30 to serve as the protection unit. The first region 41 protects the driving circuit 30 from moisture, scratch, static electricity, etc. The second region 42 covers the electrode array control circuit 20 to form a display region.

As shown in FIG. 2, the electrophoretic display panel 40 includes an electrode layer 43, a particle layer 44, and a bottom layer 45 disposed in stack. The particle layer 44 including a plurality of display particles 441 is sandwiched between the electrode layer 43 and the bottom layer 45. Each pixel in the second region 42 of the electrophoretic display panel 40 has a corresponding thin-film transistor 21 in the electrode array control circuit 20. The thin-film transistor 21 connects to a pixel electrode 50 by electrical connection or other methods. In this embodiment, the pixel electrode 50 is disposed between the electrode array control circuit 20 and the electrophoretic display panel 40. The display effect of the electrophoretic display panel 40 is achieved by the operations of the display particles 441, which are controlled by the change in the electric field between the pixel electrode 50 and the electrode layer 43. The display particles 441 in the particle layer 44 are sealed in the particle layer 44 by the bottom layer 45. The bottom layer 45 has a second surface 451 facing the electrode array control circuit 20. In this embodiment, the bottom layer 45 is made of thermoplastic elastic material. However, in other embodiments, other materials can be employed. Furthermore, in other embodiments, an adhesive layer can be formed on the second surface 451 to adhere the substrate 10 and the electrophoretic display panel 40 together.

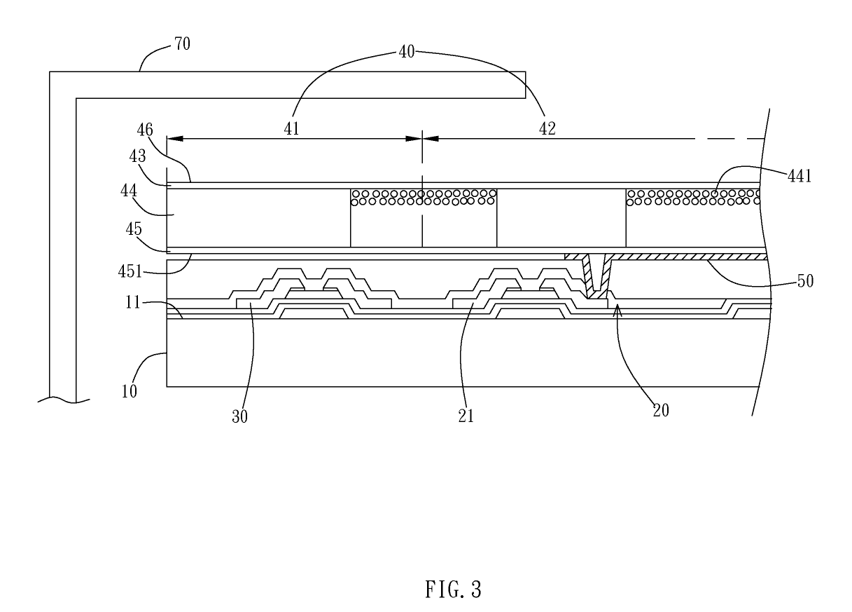

In the embodiment employing a portion of the electrophoretic display panel as the protection unit, irrelevant images might be shown at the portion of the electrophoretic display panel 40 serving as the protection unit because of the operation of the driving circuit 30 under the electrophoretic display panel 40. FIG. 3 is a schematic view of an embodiment of the flat panel display shown in FIG. 2 with an additional outer frame. As shown in FIG. 3, when the first region 41 is employed as the protection unit, an outer frame 70 can be disposed on a display surface 46 of the electrophoretic display panel 40 to cover the first region 41, so as to mask the image shown by the display particles 441 in the first region 41. On the contrary, the display particles 441 in the second region 42 not covered by the outer frame 70 can show images.

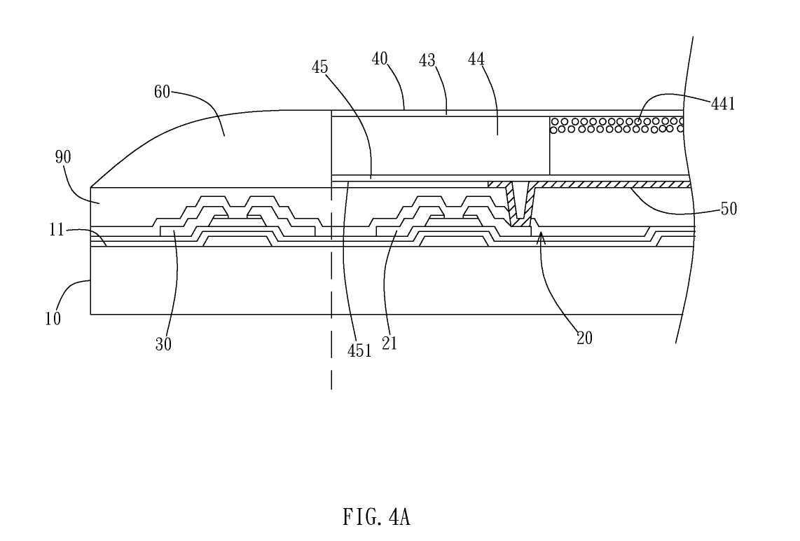

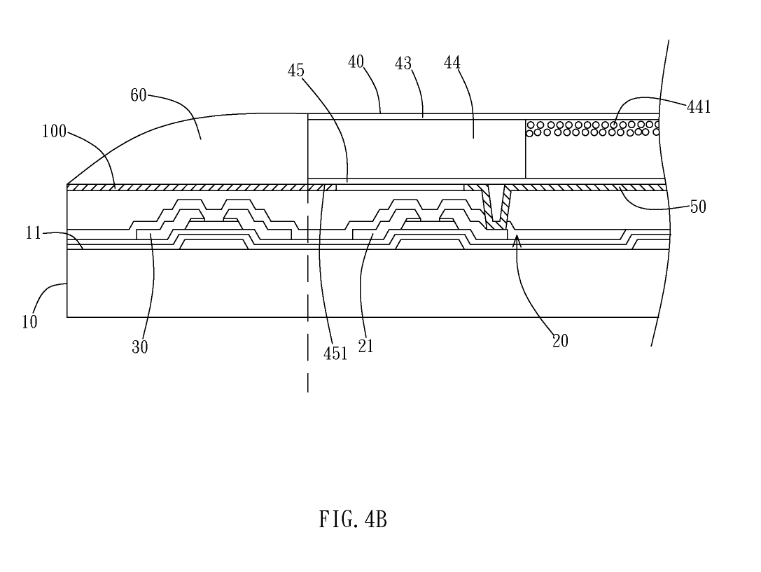

FIG. 4A is a schematic view of the second embodiment of the flat panel display of the present invention. As shown in FIG. 4A, the flat panel display includes a substrate 10, an electrode array control circuit 20, a driving circuit 30, an electrophoretic display panel 40, and a protection unit 60. The substrate 10 has a first surface 11 of the substrate 10. The electrode array control circuit 20 is formed on the first surface 11. The driving circuit 30 is formed on the first surface 11 and on one side of the electrode array control circuit 20. The driving circuit 30 connects and drives the electrode array control circuit 20. In this embodiment, a planarization layer 90 is disposed on the electrode array control circuit 20 and the driving circuit 30. However, in other embodiments, the planarization layer is optional. Besides, other structures can be employed to cover the electrode array control circuit and the driving circuit.

In this embodiment, GOA technology is employed to integrate the driving circuit 30 into the substrate 10. The driving circuit 30 drives the electrode array control circuit 20 consisting of a-Si TFTs. However, in other embodiments, the driving circuit integrated into the substrate through GOA technology can drive the electrode array control circuit consisting of p-Si TFTs while the p-Si TFTs can be formed through LTPS or other technologies. Furthermore, in other embodiments, other methods can be employed to integrate the driving circuit into the substrate.

As shown in FIG. 4A, the electrophoretic display panel 40 is disposed on the electrode array control circuit 20. The electrophoretic display panel 40 includes an electrode layer 43, a particle layer 44, and a bottom layer 45 disposed in stack. The particle layer 44 including a plurality of display particles 441 is sandwiched between the electrode layer 43 and the bottom layer 45. The display particles 441 in the particle layer 44 are sealed in the particle layer 44 by the bottom layer 45. The bottom layer 45 has a second surface 451 facing the electrode array control circuit 20. In this embodiment, the pixel electrode 50 is disposed between the electrode array control circuit 20 and the electrophoretic display panel 40.

As shown in FIG. 4A, while the driving circuit 30 is formed on the first surface 11, the protection unit 60 can be formed on one side of the electrophoretic display panel 40 to cover and protect the driving circuit 30 from exposure. In this embodiment, the protection unit 60 is formed on the driving circuit 30 by coating so as to protect the driving circuit 30 from moisture, scratch, static electricity, etc. However, in other embodiments, other methods or manufacturing processes can be employed to form the protection unit. Hence, in this embodiment, the protection unit 60 is made of ultraviolet curable resin (e.g. UV glue); however, in other embodiments, other non-conductive materials such as thermalplastic adhesive can be employed. The advantages of employing non-conductive material for the driving circuit can eliminate the cost of additional electrophoretic panel and enhance the convenience to maintain the driving circuit because the protection unit formed on the driving circuit is easier to be removed.

In the embodiment as shown in FIG. 4B, an electrode 100 is formed on the driving circuit 30. The protection unit 60 can be correspondingly formed on one side of the electrophoretic display panel 40 to cover the electrode 100 and protect the electrode 100 from exposure.

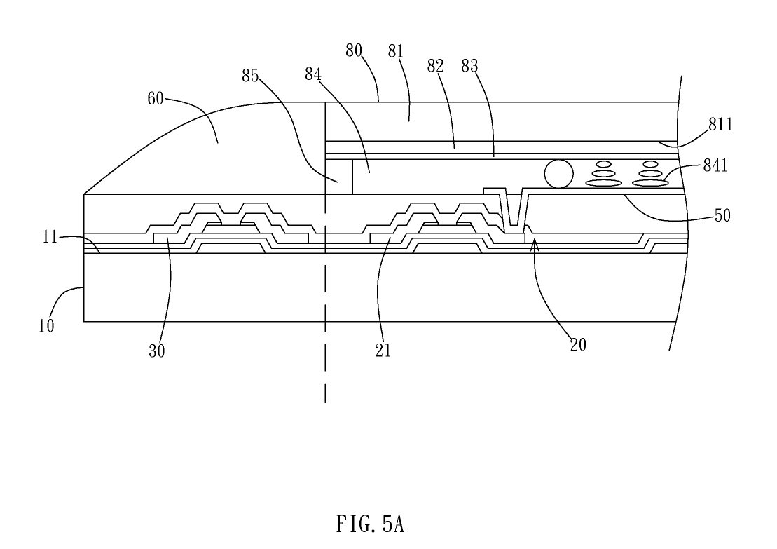

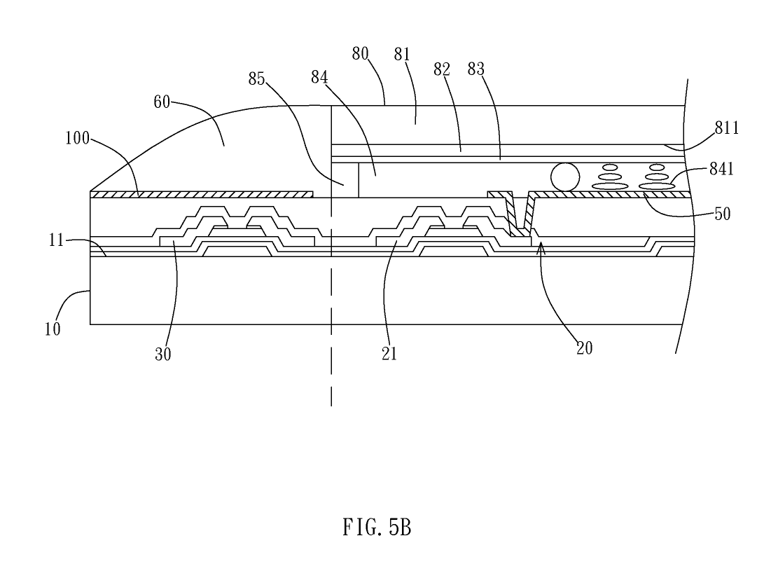

In the embodiments shown in FIG. 4A and FIG. 4B, the flat panel display of the present invention utilizes the electrophoretic display panel. However, in other embodiments, liquid crystal display panel can be utilized. As shown in FIG. 5A, the flat panel display includes a substrate 10, an electrode array control circuit 20, a driving circuit 30, a protection unit 60, and a display unit 80. The substrate 10 has a first surface 11. The electrode array control circuit 20 is formed on the first surface 11 of the substrate 10. The driving circuit 30 is formed on the first surface 11 and on one side of the electrode array control circuit 20. The driving circuit 30 connects and drives the electrode array control circuit 20.

As shown in FIG. 5A, the display unit 80 including an upper substrate 81, a color filter 82, an electrode layer 83, and a liquid crystal layer 84 is disposed on the electrode array control circuit 20. The upper substrate 81 has a second surface 811 facing the first surface 11 of the substrate 10. The color filter 82 is disposed on the second surface 811. The electrode layer 83 is sandwiched between the color filter 82 and the liquid crystal layer 84. The liquid crystal layer 84 including a plurality of liquid crystal molecules 841 faces the electrode array control circuit 20. A sealant 85 is disposed between the substrate 10 and an end of the upper substrate 81, so as to seal the liquid crystal molecules 841 between the substrate 10 and the upper substrate 81. Each pixel of the display unit 80 has a corresponding thin-film transistor 21 in the electrode array control circuit 20. The thin-film transistor 21 connects to a pixel electrode 50 by electrical connection or other methods. The pixel electrode 50 is disposed between the electrode array control circuit 20 and the display unit 80. The display effect of the flat panel display is achieved by the operation of the liquid crystal molecules 841 which is controlled by the change in electric field between the pixel electrode 50 and the electrode layer 83.

As shown in FIG. 5A, while the driving circuit 30 is formed on the first surface 11, the protection unit 60 can be formed on one side of the display unit 80 to cover and protect the driving circuit 30 from exposure. The protection unit 60 is preferably disposed on the outer side of the sealant 85. In this embodiment, the protection unit 60 is formed on the driving circuit 30 by coating so as to protect the driving circuit 30 from moisture, scratch, static electricity, etc. However, in other embodiments, other methods or manufacturing processes can be employed to form the protection unit. Hence, in this embodiment, the protection unit 60 is made of ultraviolet curable resin; however, in other embodiments, other non-conductive materials such as thermalplastic adhesive can be employed.

In the embodiment shown in FIG. 5B, an electrode 100 is formed on the driving circuit 30. The protection unit 60 can be correspondingly formed on one side of the display unit 80 to cover and protect the electrode 100 from exposure.

In comparison with the conventional LCD employing a color filter to cover the GOA circuit formed on a glass substrate. The advantages of employing non-conductive material for the driving circuit can eliminate the cost of additional LCD panel and enhance the convenience to maintain the driving circuit because the protection unit formed on the driving circuit is easier to be removed. Furthermore, other advantages such as avoidance of short circuit between the driving circuit and other elements can be also provided.

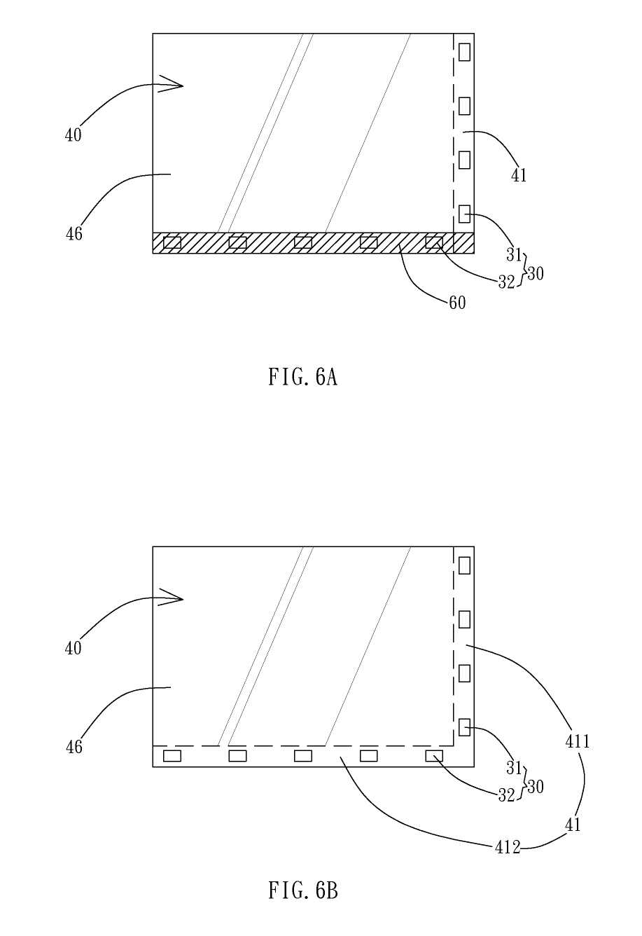

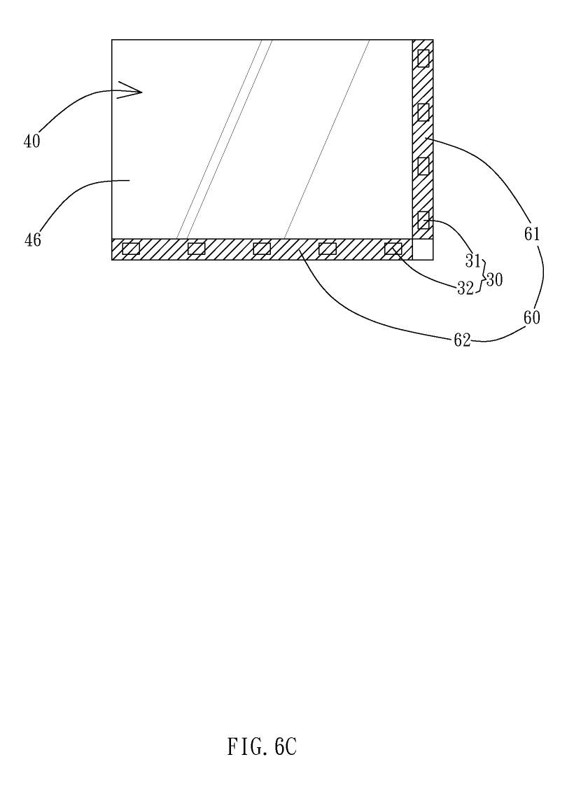

FIG. 6A is a schematic view of an embodiment of the protection unit of the flat panel display of the present invention. As shown in FIG. 6A, the driving circuit 30 includes a scanning driving unit 31 and a data driving unit 32. The scanning driving unit 31 provides scanning signals to the gate electrodes of the thin-film transistors of the electrode array control circuit by providing voltage while the data driving unit 32 provides data signals to source electrodes of the thin-film transistors of the electrode array control circuit by providing voltage. The data driving unit 32 is preferably covered by the protection unit 60 of non-conductive materials because the data signals provided by the data driving unit 32 is sensitive to noises. On the contrary, the scanning driving unit 31 is covered by the protection unit 41 formed by extending one end of the electrophoretic display panel 40.

However, in other embodiments, as shown in FIG. 6B, the scanning driving unit 31 and the data driving unit 32 can be respectively covered by the first protection unit 411 and the second protection unit 412 formed by extending different sides of the electrophoretic display panel 40. Furthermore, in other embodiments, as shown in FIG. 6C, the scanning driving unit 31 and the data driving unit 32 can be respectively covered by the first protection unit 61 and the second protection unit 62 which are made of non-conductive material and respectively disposed on different sides of the electrophoretic display panel 40. Besides the electrophoretic display panels, the disposing manner of the protection unit can also be applied to the embodiments utilizing LCD panel.

Although the present invention has been described through the above-mentioned related embodiments, the above-mentioned embodiments are merely the examples for practicing the present invention. What need to be indicated is that the disclosed embodiments are not intended to limit the scope of the present invention. On the contrary, the modifications within the essence and the scope of the claims and their equivalent dispositions are all contained in the scope of the present invention.

What is claimed is:

1. An electrophoretic display, comprising:
a substrate having a first surface;
an electrode array control circuit formed on the first surface;
at least a driving circuit formed on the first surface and on one side of the electrode array control circuit, wherein the driving circuit connects the electrode array control circuit to drive the electrode array control circuit;
an electrophoretic display panel disposed on the electrode array control circuit, wherein the electrophoretic display panel includes an electrode layer, a particle layer, and a bottom layer disposed in stack, the particle layer is disposed between the electrode layer and the bottom layer and includes a plurality of display particles, the bottom layer has a second surface facing the electrode array control circuit, wherein the electrode array control circuit controls operations of the display particles; and
at least a protection unit formed on one side of the electrophoretic display panel to cover the driving circuit.

2. The electrophoretic display of claim 1, wherein the electrophoretic display panel has a first region and a second region, the first region extends from a side of the second region and covers the driving circuit to form the protection unit while the second region covers the electrode array control circuit.

3. The electrophoretic display of claim 2, further comprising an outer frame disposed on a display surface of the electrophoretic display panel to cover the protection unit.

4. The electrophoretic display of claim 1, wherein the protection unit is an non-conductive layer.

5. The electrophoretic display of claim 4, wherein the non-conductive layer is a UV curable resin.

6. The electrophoretic display of claim 4, wherein the non-conductive layer is a thermalplastic adhesive.

7. The electrophoretic display of claim 1, wherein the electrode array control circuit is a thin-film transistor array.

8. The electrophoretic display of claim 7, wherein the thin-film transistor array includes a plurality of thin-film transistors, the driving circuit provides voltage to gate electrodes of the thin-film transistors.

9. The electrophoretic display of claim 7, wherein the thin-film transistor array includes a plurality of thin-film transistors, the driving circuit includes at least a scanning driving unit and at least a data driving unit, the scanning driving unit provides voltage to gate electrodes of the thin-film transistors while the data driving unit provides voltage to source electrodes of the thin-film transistors.

10. The electrophoretic display of claim 9, wherein the electrophoretic display panel has a first region and a second region, the first region extends from a side of the second region and covers the scanning driving unit while the second region covers the thin-film transistor array, the protection unit is an non-conductive layer covering the data driving unit.

11. The electrophoretic display of claim 10, further comprising an outer frame disposed on a display surface of the electrophoretic display panel to cover the first region.

12. The electrophoretic display of claim 1, wherein the electrophoretic display panel further includes at least an adhesive layer formed on the second surface of the electrophoretic display panel, the adhesive layer adheres the substrate and the electrophoretic display panel together.

13. The electrophoretic display of claim 1, further comprising a pixel electrode disposed on the electrode array control circuit to electrically connect the electrode array control circuit, so that the operations of the display particles can be controlled by an electric field between the pixel electrode and the electrode layer.

14. The electrophoretic display of claim 1, further comprising an electrode disposed on the driving circuit, wherein the protection unit covers the electrode.

15. A flat panel display, comprising:
a substrate having a first surface;
an electrode array control circuit formed on the first surface;
at least a driving circuit formed on the first surface and on one side of the electrode array control circuit, wherein the driving circuit connects the electrode array control circuit to drive the electrode array control circuit;
a display unit disposed on the electrode array control circuit; and
at least a protection unit formed on one side of the display unit, wherein the protection unit is an non-conductive layer to cover the driving circuit.

16. The flat panel display of claim 15, wherein the display unit includes an upper substrate, a color filter, an electrode layer, and a liquid crystal layer disposed in stack, the upper substrate has a second surface facing the first surface of the substrate, the color filter is disposed on the second surface, the electrode layer is sandwiched between the color filter and the liquid crystal layer, the liquid crystal layer faces the electrode array control circuit and includes a plurality of liquid crystal molecules, wherein the electrode array control circuit controls operations of the liquid crystal molecules.

17. The flat panel display of claim 16, further comprising a pixel electrode disposed on the electrode array control circuit to electrically connect the electrode array control circuit, so that the operations of the liquid crystal molecules are controlled by an electric field between the pixel electrode and the electrode layer.

18. The flat panel display of claim 15, further comprising an electrode disposed on the driving circuit, wherein the protection unit covers the electrode.

19. The flat panel display of claim 15, wherein the non-conductive layer is a UV curable resin.

20. The flat panel display of claim 15, wherein the non-conductive layer is a thermalplastic adhesive.

21. The flat panel display of claim 15, wherein the electrode array control circuit is a thin-film transistor array.

22. The flat panel display of claim 21, wherein the thin-film transistor array includes a plurality of thin-film transistors, the driving circuit provides voltage to gate electrodes of the thin-film transistors.

23. The flat panel display of claim 21, wherein the thin-film transistor array includes a plurality of thin-film transistors, the driving circuit includes at least a scanning driving unit and at least a data driving unit, the scanning driving unit provides voltage to gate electrodes of the thin-film transistors while the data driving unit provides voltage to source electrodes of the thin-film transistors.
